(19) United States
(12) Patent Application Publication
(10) Pub. No.: US 2026/0044743 A1
(43) Pub. Date: Feb. 12, 2026

(54) METHOD AND APPARATUS FOR TRAINING NEURAL NETWORK MODEL USING KNOWLEDGE DISTILLATION

(71) Applicant: Korea Advanced Institute of Science and Technology, Daejeon (KR)

(72) Inventors: Sung Ju HWANG, Daejeon (KR); Jeffrey Ryan WILLETTE, Daejeon (KR); Heejun LEE, Daejeon (KR); Jina KIM, Daejeon (KR)

(21) Appl. No.: 19/297,782

(22) Filed: Aug. 12, 2025

(30) Foreign Application Priority Data
Aug. 12, 2024 (KR) 10-2024-0107374

(51) Int. Cl. G06N 3/096

(52) U.S. Cl. CPC G06N 3/096

(57) ABSTRACT

A method for training a neural network model, using knowledge distillation, comprises receiving, by a pre-trained first neural network model, sequence data including one or more tokens, as input; performing knowledge distillation of one or more attention parameters for an attention operation to a second neural network model; receiving, by the second neural network model, the sequence data, as input; and training the second neural network to output an attention operation result for the sequence data based on the one or more attention parameters.

### CROSS REFERENCE TO RELATED APPLICATION

The present application claims priority to Korean Patent Application No. 10-2024-0107374, filed Aug. 12, 2024, the entire contents of which are hereby incorporated by reference in its entirety.

### BACKGROUND OF THE INVENTION

### Field of the Invention

The present invention relates to a method and apparatus for training a neural network model using knowledge distillation.

This work was supported by National Research Foundation of Korea (NRF) grant funded by the Korea government (Ministry of Science and ICT) (Project unique No.: 1711197494; Project No.: 00256259; R&D project: Individual Basic Research (Ministry of Science and ICT); Research Project Title: A generalizable, self-evolving generative model-based automated artificial intelligence framework; and Project period: 2024 Mar. 1˜2025 Feb. 28).

### Description of the Related Art

Among neural network models, a transformer, which is one example, has a problem in that, as the length of input data, for example, the number, increases, internal complexity, for example, memory complexity and computation complexity, increases in proportion to the square of the input data length.

Due to such increase in the complexity, in a large language model using the transformer, it is not possible to increase a context size for processing input text data, for example, tokens, which appears as a problem that degrades performance of the neural network model.

In order to solve this, recently, a plurality of approximated attention mechanisms having linear complexity is being proposed.

However, the existing approximated attention mechanism technologies have a problem in that they are unable to use knowledge of a pre-trained neural network model, and due to this, training accuracy of the transformer is degraded.

### SUMMARY OF THE INVENTION

The present invention is directed to providing a method and apparatus for training a neural network model using knowledge distillation capable of preventing an increase in complexity of a neural network model.

In accordance with an embodiment of a method for training a neural network model, using knowledge distillation, the method comprises receiving, by a pre-trained first neural network model, sequence data including one or more tokens, as input; performing knowledge distillation of one or more attention parameters for an attention operation to a second neural network model; receiving, by the second neural network model, the sequence data, as input; and training the second neural network to output an attention operation result for the sequence data based on the one or more attention parameters.

The training may include generating a compressed attention matrix from the sequence data; acquiring an attention mask for the compressed attention matrix based on each of a plurality of element values of the compressed attention matrix; generating a sparse attention matrix by interpolating the attention mask; and performing the attention operation on the sparse attention matrix and the sequence data.

The generating the compressed attention matrix may include generating the compressed attention matrix from the sequence data based on predetermined compression parameters, wherein one of dimensions of the compressed attention matrix is reduced in size.

The compression parameter may be set to a value smaller than a length of the sequence data.

The acquiring the attention mask may include extracting element values equal to or greater than a predetermined reference value among the plurality of element values of the compressed attention matrix; mapping the extracted element values to 1, and mapping remaining element values other than the extracted element values to 0; and acquiring the attention mask including the mapped plurality of element values.

The generating the sparse attention matrix may include generating a sparse mask by interpolating the attention mask to have a same length as the sequence data; and generating the sparse attention matrix by performing matrix multiplication between the sequence data and the sparse mask.

The one or more attention parameters may include an attention matrix generated by the first neural network model and the attention operation result for the sequence dat. Also, the training may include interpolating the compressed attention matrix generated by the second neural network model, and determining a first loss value based on a comparison result of the interpolated attention matrix and the attention matrix of the first neural network model; determining a second loss value based on a comparison result of an attention operation result of the second neural network model and an attention operation result of the first neural network model; and adjusting one or more parameters of the second neural network model such that a total loss value based on a sum of the first loss value and the second loss value becomes minimized.

In accordance with another embodiment of a method for an apparatus for training a neural network model, using knowledge distillation, the apparatus comprising: a memory storing a model training program and at least one instruction; and a processor executing the at least one instruction stored in the memory, wherein the at least one instruction, when executed by the processor, causes the processor to: receive, by a pre-trained first neural network model, sequence data including one or more tokens, as input; perform knowledge distillation of one or more attention parameters for an attention operation to a second neural network model; receive, by the second neural network model, the sequence data, as input; and train the second neural network to output an attention operation result for the sequence data based on the one or more attention parameters.

The at least one instruction, when executed by the processor, may cause the processor to further: train the second neural network to generate a compressed attention matrix from the sequence data; acquire an attention mask for the compressed attention matrix based on each of a plurality of element values of the compressed attention matrix; generate a sparse attention matrix by interpolating the attention mask; and perform the attention operation on the sparse attention matrix and the sequence data.

The at least one instruction, when executed by the processor, may cause the processor to further train the second neural network to generate the compressed attention matrix from the sequence data based on predetermined compression parameters, wherein one of dimensions of the compressed attention matrix is reduced in size.

The compression parameter may be set to a value smaller than a length of the sequence data.

The at least one instruction, when executed by the processor, may cause the processor to further train the second neural network to extract element values equal to or greater than a predetermined reference value among the plurality of element values of the compressed attention matrix; map the extracted element values to 1, and map remaining element values other than the extracted element values to 0; and acquire the attention mask including the mapped plurality of element values.

The at least one instruction, when executed by the processor, may cause the processor to further generate a sparse mask by interpolating the attention mask to have a same length as the sequence data; and generate the sparse attention matrix by performing matrix multiplication between the sequence data and the sparse mask.

The one or more attention parameters may include an attention matrix generated by the first neural network model and the attention operation result for the sequence data. Also, the at least one instruction, when executed by the processor, may cause the processor to further interpolate the compressed attention matrix generated by the second neural network model, and determine a first loss value based on a comparison result of the interpolated attention matrix and the attention matrix of the first neural network model; determine a second loss value based on a comparison result of an attention operation result of the second neural network model and an attention operation result of the first neural network model; and adjust one or more parameters of the second neural network model such that a total loss value based on a sum of the first loss value and the second loss value becomes minimized.

In accordance with another embodiment of a non-transitory computer-readable storage medium storing computer-executable instructions, the computer executable instructions, when executed by a processor, cause the processor to perform a method, the method comprising: receiving, by a pre-trained first neural network model, sequence data including one or more tokens, as input; performing knowledge distillation of one or more attention parameters for an attention operation to a second neural network model; receiving, by the second neural network model, the sequence data, as input; and training the second neural network to output an attention operation result for the sequence data based on the one or more attention parameters.

The present invention may prevent an increase in the complexity of the neural network model even if the number of input sequence data increases, by training the neural network model to output an attention operation result for the sequence data by generating a sparse attention matrix for the sequence data input into the neural network model.

In addition, the present invention, by enabling training to be performed such that a teacher model, which is a pre-trained neural network model, provides attention parameters through knowledge distillation to a student model, which is a neural network model that has to perform training, may eliminate a training deviation between the teacher model and the student model, and due to this, may improve training performance and efficiency of the neural network model.

### BRIEF DESCRIPTION OF THE DRAWINGS

FIG. 1 is a diagram illustrating an apparatus for training a neural network model according to an embodiment of the present invention.

FIG. 2 is a diagram conceptually illustrating functions of the model training program in FIG. 1.

FIGS. 3 and 4 are diagrams illustrating a method for training a neural network model using knowledge distillation according to an embodiment of the present invention.

FIG. 5 is a diagram specifically illustrating a method for training the second neural network model in FIG. 4.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing embodiments of the present invention, if it is considered that a detailed description of a known function or configuration may unnecessarily obscure the gist of the present invention, the detailed description will be omitted. In addition, the terms described below are terms defined in consideration of functions in the embodiments of the present invention, the terms may vary according to the intention or precedent of a technician working in the field, the emergence of new technologies, and the like. Therefore, the terms used in the present disclosure should be defined based on the meaning of the terms and the overall contents of the present disclosure, not just the name of the terms.

Hereinafter, the embodiment of the present disclosure will be described in detail with reference to the accompanying drawings so that those of ordinary skill in the art may easily implement the present disclosure.

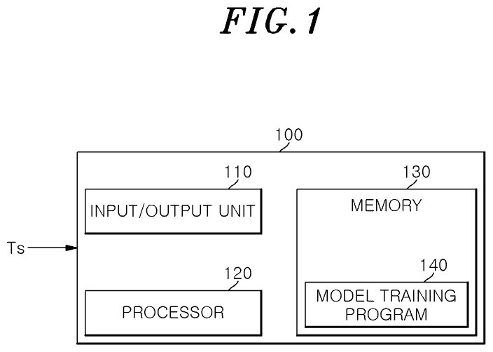

FIG. 1 is a diagram illustrating an apparatus for training a neural network model according to an embodiment of the present invention.

With reference to FIG. 1, an apparatus 100 for training a neural network model according to the present embodiment may include an input/output unit 110, a processor 120, and a memory 130.

The input/output unit 110 may receive training data, for example, sequence data (Ts), from the outside. Here, the sequence data (Ts) may include one or more tokens, and each token may include a value for each of a query, a key, and a value.

The processor 120 may receive the sequence data (Ts) from the input/output unit 110, and may train one or more neural network models, using a model training program 140 stored in the memory 130.

The memory 130 may store the model training program 140 and information necessary for execution thereof. The model training program 140 may be software including instructions capable of training a neural network model based on the training data provided from the input/output unit 110, that is, the sequence data.

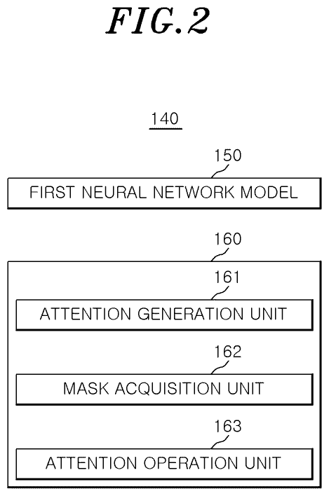

FIG. 2 is a diagram conceptually illustrating functions of the model training program in FIG. 1.

With reference to FIG. 2, the model training program 140 according to the present embodiment may include a first neural network model 150 and a second neural network model 160.

The first neural network model 150 may be a pre-trained model by the sequence data (Ts). The first neural network model 150 may perform knowledge distillation of weight parameters according to training results, for example, one or more attention parameters according to attention operation of the sequence data (Ts), to the second neural network model 160. The first neural network model 150 may be a teacher model.

Here, the attention parameters to be knowledge-distilled from the first neural network model 150 may include at least one of an attention matrix generated by the first neural network model 150 from the sequence data (Ts) or an attention operation result for the sequence data (Ts). The second neural network model 160 may receive, as input, the sequence data (Ts) and may output an attention operation result for the sequence data (Ts) based on one or more attention parameters knowledge-distilled from the first neural network model 150. Such a second neural network model 160 may be a student model that performs training according to the sequence data (Ts) and parameters provided through knowledge distillation from the first neural network model 150.

The second neural network model 160 may include an attention generation unit 161, a mask acquisition unit 162, and an attention operation unit 163.

The attention generation unit 161, when receiving, as input, the sequence data (Ts), may generate a compressed attention matrix based on predetermined compression parameters.

Here, the compression parameter may be set to a value smaller than a length of the sequence data (Ts). In this case, as described above, since the sequence data (Ts) includes one or more tokens, the length of the sequence data (Ts) may be a value corresponding to the number of tokens included in the sequence data (Ts). Accordingly, in case where the length of the sequence data (Ts) is T, a compression parameter t may be set to satisfy T>t (where T and t are natural Numbers).

Therefore, the attention generation unit 161 of the present embodiment may generate a compressed attention matrix of T×t from the sequence data (Ts), that is, an attention matrix in which one of the dimensions has been reduced to a compressed length.

The mask acquisition unit 162 may acquire an attention mask for the compressed attention matrix based on each of a plurality of element values of the compressed attention matrix generated by the attention generation unit 161.

For example, the mask acquisition unit 162 may extract element values having values equal to or greater than a predetermined reference value among the plurality of element values. Then, the mask acquisition unit 162 may map the extracted element values to 1, and may map the remaining element values other than the extracted element values to 0. Accordingly, the mask acquisition unit 162 may acquire an attention mask having values mapped to 0 and 1 corresponding to the plurality of element values of the compressed attention matrix.

Here, the attention mask may have the same shape as the compressed attention matrix, for example, a size of T×t. That is, since the mask acquisition unit 162 acquires an attention mask in which each and every element value of the compressed attention matrix is mapped to 0 or 1, such an attention mask may have a form that is substantially the same as the compressed attention matrix, except that the element values are different.

The attention operation unit 163 may generate a sparse attention matrix by interpolating the attention mask acquired by the mask acquisition unit 162, and may perform attention operation on the sequence data (Ts) and the sparse attention matrix.

For example, the attention operation unit 163 may generate a sparse mask by extending and interpolating an attention mask such that it becomes equal to a length of sequence data (Ts). Then, the attention operation unit 163 may generate a sparse attention matrix by performing a matrix multiplication operation between the generated sparse mask and the sequence data (Ts).

Here, as described above, since the attention mask is the same as a compressed attention matrix, it may have a size of T×t. In addition, the sequence data (Ts) may have a length of T depending on the number of tokens included therein. Accordingly, the attention operation unit 163 may generate a sparse mask having a size of T×T by extending and interpolating the attention mask having a size of T×t such that it has the same length as the sequence data (Ts), that is, a size of T×T.

In addition, the attention operation unit 163 may output an attention operation result for the sequence data (Ts) by performing an attention operation between the generated sparse attention matrix and the sequence data (Ts).

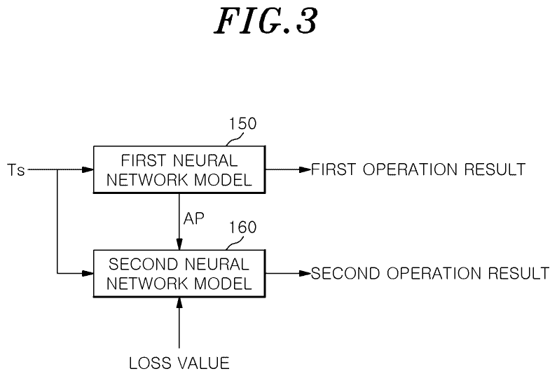

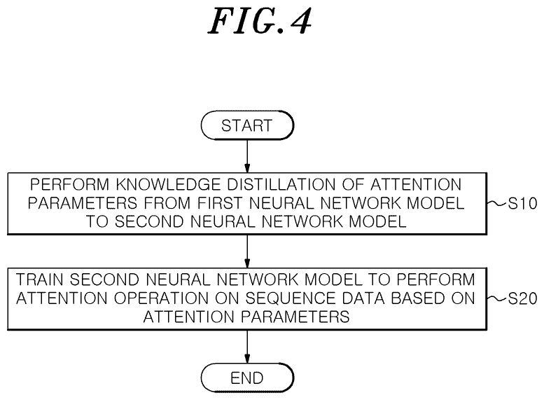

FIGS. 3 and 4 are diagrams illustrating a method for training a neural network model using knowledge distillation according to an embodiment of the present invention.

With reference to the drawings, the apparatus 100 for training a neural network model according to the present embodiment may receive sequence data (Ts) including one or more tokens from the outside.

The processor 120 may execute the model training program 140 stored in the memory 130, and may input the sequence data (Ts) provided through the input/output unit 110 to the first neural network model 150.

Here, the first neural network model 150 may be a pre-trained neural network model, as described above. Accordingly, the first neural network model 150 may perform an attention operation for the received sequence data (Ts) as input and may output an attention operation result, for example, a first operation result.

Then, the first neural network model 150 may provide, through knowledge distillation, one or more attention parameters (AP) according to the attention operation for the sequence data (Ts), for example, an attention parameters (AP) including an attention matrix generated by the first neural network model 150 or the first operation result, to the second neural network model 160 (S10).

Next, the processor 120 may input the sequence data (Ts) provided through the input/output unit 110 to the second neural network model 160, that is, a neural network model that has to perform training.

Accordingly, the second neural network model 160 may perform an attention operation for the sequence data (Ts) based on the one or more attention parameters (AP) provided from the first neural network model 150, and may be trained to output an attention operation result, for example, a second operation result (S20).

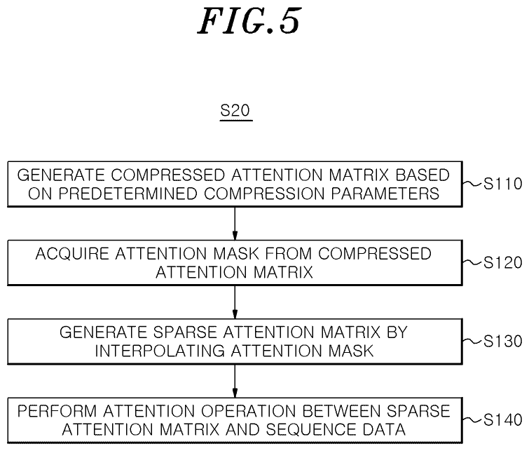

FIG. 5 is a diagram specifically illustrating a method for training the second neural network model in FIG. 4.

With reference to FIG. 5, an attention generation unit 161 of the second neural network model 160, when receiving the sequence data (Ts) as input, may generate a compressed attention matrix based on predetermined compression parameters (S110).

Here, the compression parameter may be set to a value smaller than a length of the sequence data (Ts). Accordingly, the attention generation unit 161 may generate a compressed attention matrix from the sequence data (Ts), in which one of the matrix dimensions has been reduced to a compressed length.

Next, the mask acquisition unit 162 may acquire an attention mask for the compressed attention matrix based on each of a plurality of element values of the compressed attention matrix generated by the attention generation unit 161 (S120).

Here, the mask acquisition unit 162 may extract element values having values equal to or greater than a predetermined reference value among the plurality of element values, map the extracted element values to 1, and map the remaining element values other than the extracted element values to 0, thereby acquiring an attention mask having values mapped to 0 and 1.

Next, the attention operation unit 163 may generate a sparse attention matrix by interpolating the attention mask acquired by the mask acquisition unit 162 (S130).

Here, the attention operation unit 163 may generate a sparse mask by extending and interpolating an attention mask such that it becomes equal to a length of sequence data (Ts). Then, the attention operation unit 163 may generate a sparse attention matrix by performing a matrix multiplication operation between the generated sparse mask and the sequence data (Ts).

Subsequently, the attention operation unit 163 may perform an attention operation between the generated sparse attention matrix and the sequence data (Ts) to output an attention operation result for the sequence data (Ts), that is, the second operation result (S140).

As such, the second neural network model 160 of the present embodiment may be trained to generate a sparse attention matrix from the input sequence data (Ts) and to output an attention operation result for the sequence data (Ts), using the same.

Accordingly, the present invention may prevent an increase in complexity of a neural network model, even if the number of sequence data (Ts) input from the outside increases.

In addition, the present invention, by providing attention parameters from a pre-trained neural network model, for example, a teacher model, to a neural network model to be trained, for example, a student model, through knowledge distillation, and by allowing the student model to perform training based on the attention parameters that are knowledge-distilled, may eliminate a training deviation between the teacher model and the student model, and thereby improving training performance and efficiency of the neural network model.

Meanwhile, the second neural network model 160 may determine a loss value based on attention parameters knowledge-distilled from the first neural network model 150, and may repeat training to perform the attention operation for the above-described sequence data (Ts) while adjusting internal parameters such that the loss value becomes minimized.

With reference to FIG. 3, one or more attention parameters knowledge-distilled from the first neural network model 150 to the second neural network model 160 may include an attention matrix generated from the sequence data (Ts) by the first neural network model 150 and an attention operation result for the sequence data (Ts) of the first neural network model 150, that is, the first operation result.

Accordingly, the second neural network model 160 may extend and interpolate a compressed attention matrix generated from the sequence data (Ts) by an attention generation unit 161 according to a length of the sequence data (Ts), and may compare the interpolated attention matrix with the attention matrix knowledge-distilled from the first neural network model 150. Accordingly, the second neural network model 160 may determine a first loss value from a comparison result of attention matrices.

In addition, the second neural network model 160 may compare a result according to the attention operation, that is, the second operation result, with the first operation result knowledge-distilled from the first neural network model 150. Accordingly, the second neural network model 160 may determine a second loss value from a comparison result of attention operation results.

Then, the second neural network model 160 may further receive, as input, a total loss value based on a sum of the first loss value and the second loss value, and may adjust one or more internal parameters such that the total loss value becomes minimized.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for training a neural network model, using knowledge distillation, to be performed by an apparatus for training a neural network model, the method comprising:
receiving, by a pre-trained first neural network model, sequence data including one or more tokens, as input;
performing knowledge distillation of one or more attention parameters for an attention operation to a second neural network model;
receiving, by the second neural network model, the sequence data, as input; and
training the second neural network to output an attention operation result for the sequence data based on the one or more attention parameters.

2. The method of claim 1, wherein the training includes:
generating a compressed attention matrix from the sequence data;
acquiring an attention mask for the compressed attention matrix based on each of a plurality of element values of the compressed attention matrix;
generating a sparse attention matrix by interpolating the attention mask; and
performing the attention operation on the sparse attention matrix and the sequence data.

3. The method of claim 2, wherein the generating the compressed attention matrix includes:
generating the compressed attention matrix from the sequence data based on predetermined compression parameters,
wherein one of dimensions of the compressed attention matrix is reduced in size.

4. The method of claim 3, wherein the compression parameter is set to a value smaller than a length of the sequence data.

5. The method of claim 2, wherein the acquiring the attention mask includes:
extracting element values equal to or greater than a predetermined reference value among the plurality of element values of the compressed attention matrix;
mapping the extracted element values to 1, and mapping remaining element values other than the extracted element values to 0; and
acquiring the attention mask including the mapped plurality of element values.

6. The method of claim 2, wherein the generating the sparse attention matrix includes:
generating a sparse mask by interpolating the attention mask to have a same length as the sequence data; and
generating the sparse attention matrix by performing matrix multiplication between the sequence data and the sparse mask.

7. The method of claim 2, wherein the one or more attention parameters include an attention matrix generated by the first neural network model and the attention operation result for the sequence data, and
wherein the training includes:
interpolating the compressed attention matrix generated by the second neural network model, and determining a first loss value based on a comparison result of the interpolated attention matrix and the attention matrix of the first neural network model;
determining a second loss value based on a comparison result of an attention operation result of the second neural network model and an attention operation result of the first neural network model; and
adjusting one or more parameters of the second neural network model such that a total loss value based on a sum of the first loss value and the second loss value becomes minimized.

8. An apparatus for training a neural network model, using knowledge distillation, the apparatus comprising:
a memory storing a model training program and at least one instruction; and
a processor executing the at least one instruction stored in the memory,
wherein the at least one instruction, when executed by the processor, causes the processor to:
receive, by a pre-trained first neural network model, sequence data including one or more tokens, as input;
perform knowledge distillation of one or more attention parameters for an attention operation to a second neural network model;
receive, by the second neural network model, the sequence data, as input; and
train the second neural network to output an attention operation result for the sequence data based on the one or more attention parameters.

9. The apparatus of claim 8, wherein the at least one instruction, when executed by the processor, causes the processor to further:
train the second neural network to:
generate a compressed attention matrix from the sequence data;
acquire an attention mask for the compressed attention matrix based on each of a plurality of element values of the compressed attention matrix;
generate a sparse attention matrix by interpolating the attention mask; and
perform the attention operation on the sparse attention matrix and the sequence data.

10. The apparatus of claim 9, wherein the at least one instruction, when executed by the processor, causes the processor to further:
train the second neural network to:
generate the compressed attention matrix from the sequence data based on predetermined compression parameters,
wherein one of dimensions of the compressed attention matrix is reduced in size.

11. The apparatus of claim 10, wherein the compression parameter is set to a value smaller than a length of the sequence data.

12. The apparatus of claim 9, wherein the at least one instruction, when executed by the processor, causes the processor to further:
train the second neural network to:
extract element values equal to or greater than a predetermined reference value among the plurality of element values of the compressed attention matrix;
map the extracted element values to 1, and map remaining element values other than the extracted element values to 0; and
acquire the attention mask including the mapped plurality of element values.

13. The apparatus of claim 9, wherein the at least one instruction, when executed by the processor, causes the processor to further:
generate a sparse mask by interpolating the attention mask to have a same length as the sequence data; and
generate the sparse attention matrix by performing matrix multiplication between the sequence data and the sparse mask.

14. The apparatus of claim 9, wherein the one or more attention parameters include an attention matrix generated by the first neural network model and the attention operation result for the sequence data, and
wherein the at least one instruction, when executed by the processor, causes the processor to further:
interpolate the compressed attention matrix generated by the second neural network model, and determine a first loss value based on a comparison result of the interpolated attention matrix and the attention matrix of the first neural network model;
determine a second loss value based on a comparison result of an attention operation result of the second neural network model and an attention operation result of the first neural network model; and
adjust one or more parameters of the second neural network model such that a total loss value based on a sum of the first loss value and the second loss value becomes minimized.

15. A non-transitory computer-readable storage medium storing a computer program, wherein the computer program, when executed by a processor, includes instructions for causing the processor to perform a method, the method comprising:
receiving, by a pre-trained first neural network model, sequence data including one or more tokens, as input;
performing knowledge distillation of one or more attention parameters for an attention operation to a second neural network model;
receiving, by the second neural network model, the sequence data, as input; and
training the second neural network to output an attention operation result for the sequence data based on the one or more attention parameters.
